(19) United States
(12) Patent Application Publication
(10) Pub. No.: US 2015/0110608 A1
(43) Pub. Date: Apr. 23, 2015

(54) RETENTION SYSTEM AND METHOD FOR VANE RING ASSEMBLY

(71) Applicant: BorgWarner Inc., Auburn Hills, MI (US)

(72) Inventor: Rajendra Vemula, Arden, NC (US)

(73) Assignee: BorgWarner Inc., Auburn Hills, MI (US)

(21) Appl. No.: 14/388,943

(22) PCT Filed: Mar. 22, 2013
(86) PCT No.: PCT/US13/33423

§ 371 Date: Sep. 29, 2014

Related U.S. Application Data
(60) Provisional application No. 61/619,624, filed on Apr. 3, 2012.

(51) Int. Cl. F02B 37/24; F02B 39/00

(52) U.S. Cl. CPC F02B 37/24; F02B 39/00
USPC 415/159; 60/605.1; 29/889.21

(57) ABSTRACT

A variable geometry turbocharger includes a vane pack having rotatable vanes constrained by a pair of vane rings held together by a plurality of pins. A first end of each pin can be configured with a head. Each pin is received in a pair of aligned apertures in the vane rings such that the head of each pin engages one of the vane rings. A second end of each pin is deformed (e.g., by orbital riveting) such that it engages the other vane ring. Thus, a clamp load is applied to the vane rings, which can control the parallelism and distance between the vane rings so that the vanes can rotate with a minimum clearance without jamming. Also, the pins can maintain vane axle apertures in the vane rings in the correct angular position relative to each other. Such a vane pack configuration can reduce process time and cost.

### FIELD OF THE INVENTION

Embodiments related in general to turbochargers and, more particularly, to vane packs for variable turbine geometry turbochargers.

### BACKGROUND OF THE INVENTION

Turbochargers are a type of forced induction system. They deliver air, at greater density than would be possible in the normally aspirated configuration, to the engine intake, allowing more fuel to be combusted, thus boosting the engine's horsepower without significantly increasing engine weight. A smaller turbocharged engine, replacing a normally aspirated engine of a larger physical size, will reduce the mass and can reduce the aerodynamic frontal area of the vehicle.

FIG. 1 shows a typical variable geometry turbocharger (10). Generally, turbochargers (10) use the exhaust flow from the engine exhaust manifold to drive a turbine wheel (12), which is located in a turbine housing (14) to form a turbine stage (16). The energy extracted by turbine wheel (12) is translated to a rotating motion which then drives a compressor wheel (18), which is located in a compressor cover (20), to form a compressor stage (22). The compressor wheel (18) draws air into the turbocharger (10), compresses this air and delivers it to the intake side of the engine.

Variable geometry turbochargers typically use a plurality of rotatable vanes (24) to control the mass flow of exhaust gas which impinges on the turbine wheel (12) and control the power of the turbine stage (16). These vanes (24) also therefore control the pressure ratio generated by the compressor stage (22). In engines, which control the production of NOx by the use of High Pressure Exhaust Gas Recirculation (HP EGR) techniques, the function of the vane pack in a variable geometry turbocharger also provides a means for controlling and generating exhaust back pressure.

A plurality of vanes (24) is provided between a generally annular upper vane ring (UVR) (28), and a generally annular lower vane ring (LVR) (30). The assembly consisting of the plurality of vanes (24) and the two vane rings (28, 30) is typically known as the vane pack (26). Each vane (24) rotates on a pair of opposing axles (32), protruding from opposite sides of the vane (24) with the axles (32) on the same centerline. For each vane (24), one of the axles (32) is located in an aperture (34) in the LVR (30), and the other axle (32) is located in an aperture (36) in the UVR (28). The angular orientation of the UVR (28) is set such that the complementary apertures (34, 36) in the vane rings (28, 30) are concentric with the axles (32) of the vane (24). The vane (24) is free to rotate about the centerline of the two axles (32), which is concentric with the now established centerline of the two apertures (34, 36). Each axle (32) on the UVR side of the vane (24) protrudes through the UVR (28) and is affixed to a respective vane arm (38), which controls the rotational position of the vane (24) with respect to the vane rings (28, 30). Typically there is a separate unison ring which controls all of the vane arms (38) in unison. This unison ring is controlled by an actuator, which is typically commanded by the engine electronic control unit (ECU).

The clearance between the rotatable vanes (24), more specifically between the cheeks (40) of the vanes (24), and the inner surfaces (29, 31) of the upper and lower vane rings (28, 30), is a major contributor to a loss of efficiency in both the control of exhaust gas allowed to impinge on the turbine wheel (14) and in the generation of backpressure upstream of the turbine wheel (14). It is desirable to minimize the clearances between the vane cheeks (40) and the complementary inner surfaces (29, 31) of the vane rings (28, 30) and thus increase the efficiency of the vane pack (26). Unfortunately, the increase in efficiency due the side clearances is inversely proportional to the propensity of the vane pack (26) to wear, stick, or completely jam due to thermal deformation in the turbine housing (14) being transferred to the vane pack (26). So the vane pack (26) needs to be accurately placed and constrained within the turbine housing (14) in a manner which minimizes the transference of thermally induced distortion. While internal to the vane pack (26), the noted clearances need to be such that they maximize efficiency while minimizing the potential for sticking, jamming and wear.

In some VTGs, as depicted in FIG. 2, the LVR (30) is constrained against the turbine housing (14) by a plurality of bolts (42). The UVR 30 and the lower vane ring LVR (20) are held together by studs or bolts (44), which serve to apply a clamp load on the vane rings (28, 30), and on a plurality of spacers (46) placed between the vane rings (28, 30), such that the length of the spacer (46) determines the distance between the UVR (28) and the LVR (30), and thus the clearance between the cheeks (40) of the vanes (24) and the inner surfaces (29, 31) of the vane rings (28, 30). The bolts or studs (4) also serve to provide the angular orientation of the apertures (34, 36) in which the axles (32) of the vanes are constrained. However, such studs are difficult to secure so that they do not unscrew when subjected to vibration, especially in situations where there are high temperature (from 740° C. to 1050° C.). Similarly, in a situation where the temperature can range from below freezing to high combustion-like temperatures (from 740° C. to 1050° C.), it is difficult to maintain clamp load via a nut (48) so that the nut (48) does not come loose due to the differences in coefficients of thermal expansion between the materials of the components in the clamp load set. Thus, what may appear to be a simple clamping device (i.e., a nut and bolt) is actually a complicated engineering issue, which typically requires the use of exotic and expensive materials for the components so that the clamp load is maintained over the aforementioned range of temperatures.

Instead of bolts or studs, it is also known for the UVR 30 and the lower vane ring LVR (20) to held together by pins (not shown) that are orbitally riveted at both ends to apply a clamp load on the vane rings (28, 30) and on a plurality of spacers (46) placed between the vane rings (28, 30). However, orbital riveting both ends of the pins increases manufacturing time and its ability to retain the vane pack (26) at operating and high temperatures is uncertain.

During the assembly of the vane pack (26), much effort is spent to ensure that the correct components are used and that the correct clamp loads are applied. Thus, there is a need cost-effective and relatively fast way to apply the desired clamp load to a vane pack.

### SUMMARY OF THE INVENTION

Embodiments herein can minimize the above problems by the using a plurality of pins having a head at one end. The other end of each pin can be deformed by any suitable process, such as orbital riveting. Because of such an arrangement, a clamp load can be applied on the vane rings and the spacer. Thus, the vane ring axial spacing can be controlled. Further, the angular orientation between the vane rings can be maintained so that the axles on the vanes can be concentric with the apertures in which they rotate.

### BRIEF DESCRIPTION OF THE DRAWINGS

Embodiments are illustrated by way of example and not limitation in the accompanying drawings in which like reference numbers indicate similar parts and in which:

FIG. 1 shows a typical variable geometry turbocharger;

FIG. 2 is a section view and a further magnified view of a typical vane pack;

FIG. 3 is a cross-sectional view of an example of a vane pack;

FIG. 4 is a view of the vane pack;

FIG. 5 is a cross-sectional view of an example of a deformed second end of a pin for a vane pack; and

FIG. 6 is a cross-sectional view of an example of a deformed second end of a pin for a vane pack.

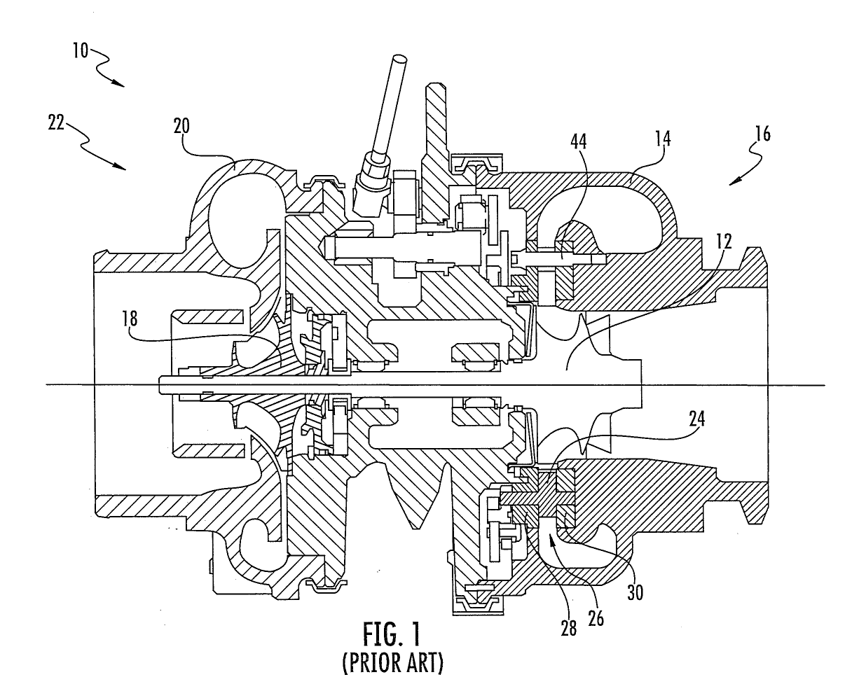

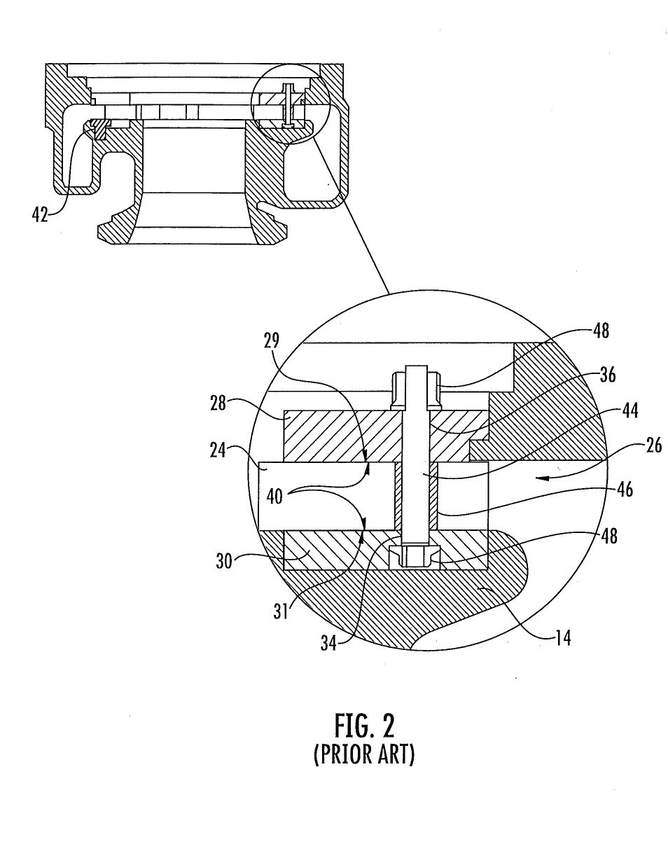

### DETAILED DESCRIPTION OF THE INVENTION

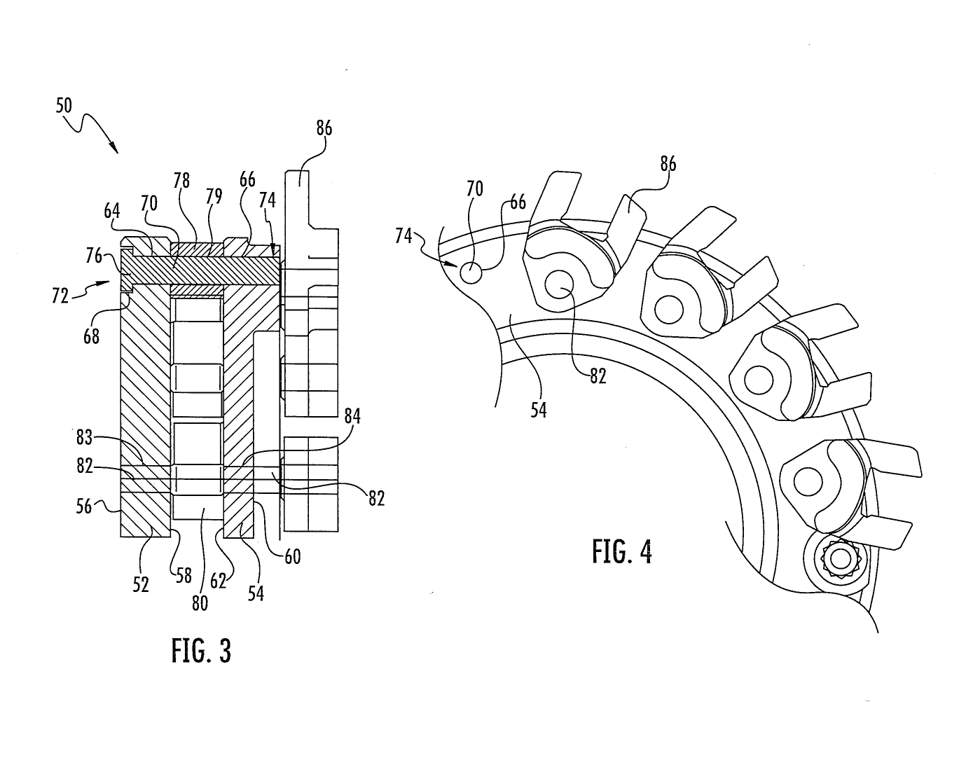

Arrangements described herein relate to a retention system and method for a vane ring assembly. Detailed embodiments are disclosed herein; however, it is to be understood that the disclosed embodiments are intended only as exemplary. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Arrangements are shown in FIGS. 3-6, but the embodiments are not limited to the illustrated structure or application.

Referring to FIG. 3, a cross-sectional view of an example of a vane pack (50) configured according to embodiment herein is shown. The vane pack (50) includes a lower vane ring (LVR) (52) and an upper vane ring (UVR) (54). The LVR (52) and the UVR (54) can be generally annular. The LVR (52) can have an outer surface (56) and an inner surface (58). Likewise, the UVR (54) can have an outer surface (60) and an inner surface (62). The term “inner” and “outer” are used with respect to the vanes (80) located between the LVR (52) and UVR (54). That is, the inner surfaces (58, 62) face toward the vanes (80), whereas the outer surfaces (56, 60) face away from the vanes (80).

A plurality of apertures (64) can be provided in the LVR (52), and a plurality of apertures (66) can be provided in the UVR (54). The LVR (52) can also include a counterbore (68) is fabricated into the outer surface (56). The UVR (54) and/or LVR (52) can be arranged such that each of the apertures (64) in the LVR (52) is substantially aligned with a respective one of the apertures (66) in the UVR (54).

The vane pack (50) can include a plurality of pins (70). Each pin (70) can have a first end (72) and a second end (74). The first end (72) of the pins (70) can include a head (76). The pins (70) can have any suitable cross-sectional size and shape. In one embodiment, the pins (70) can have a substantially circular cross-sectional shape. However, embodiments are not limited to this conformation. The pins (70) can be substantially straight. The pins (70) can be made of any suitable material, including, for example, PL 23, PLNi40 or A286. The pins (70) can also be made of superalloys, such as Hastelloy.

Each pin (70) can be received in a respective pair of aligned apertures (64, 66) of the LVR (52) and the UVR (54). Each pin (70) can be received in a respective one of the apertures (64) of the LVR (52) from the outer surface (56) side thereof. The pin (70) and/or the LVR (52) can be moved relative to each other until the head (76) of the pin (70) engages the LVR (52). In some instances, the head (76) of the pin (70) can engage the outer surface (56) of the LVR (52). In embodiments, a counterbore (68) can be formed the outer surface (56) of the LVR (52). The counterbore (68) can be sized to receive at least a portion of the head (76) of the pin (70). More particularly, the counterbore (68) can be sized so that the entire head (76) of the pin (70) is received therein. The head (76) of the pin (70) can be substantially flush with the outer surface (56) of the LVR (52). Alternatively, the head (76) of the pin (70) can be recessed from the outer surface (56) of the LVR (52), such as by being received in the counterbore (68). Such a condition may be desired to ensure that the LVR (52) mounts correctly within the turbine housing (14). Still alternatively, the head (76) of the pin (70) can protrude beyond the outer surface (56) of the LVR (52). In at least some instances,

A plurality of spacers (78) can be provided to control the axial distance between the inner surface (58) of the LVR (52) and the inner surface (62) of the UVR (54). Each pin (70) can pass through a respective one of the spacers (78). The spacers (78) can have a passage (79) configured to receive a pin (70). The length of the spacers (78) can be slightly longer than the axial length of the vanes (80). The spacers (78) can have any suitable configuration. For instance, the spacers (78) can be generally cylindrical, or they can be an aerodynamically efficient shape.

Each of the vanes (80) can include a pair of vane axles (82). For each vane (80), the vane axle (82) on the LVR side of the vane (80) can be inserted into a respective aperture (83) in the LVR (52). The UVR (54) can be located over the pins (70) and the vane axles (82) on the UVR side of the vane (80). The second end (74) of each pin (70) can be received in a respective aperture (66) of the UVR (54). The second end (74) of each pin (70) may or may not extend beyond the outer surface (60) of the UVR (54). In some instances, the second end (74) of each pin (70) can be substantially flush with the outer surface (60) of the UVR (54). The vane axels (82) on the UVR side of each vane (80) can be received in a respective aperture (84) in the UVR (54).

Referring to FIGS. 6-7, once the pins (70) are inserted into the vane rings (52, 54) and through their respective spacer (78), the second end (74) of each pin (70) can be deformed. The second end (74) of each pin (70) can be deformed using any suitable process. For instance, the second end (74) of each pin (70) can be deformed by orbital riveting. In some instances, orbital riveting can include an eccentric anvil rolling or peening the material into the desired shape. Alternatively or in addition, the second end (74) of each pin (70) can be deformed by radial riveting (as known as spiralform). In some instances, radial riveting can include repeated impact of the material while an anvil orbits the end of the pin. The second end (74) of each pin (70) can be deformed by rollerform riveting. Alternatively or in addition to the above possibilities, the second end (74) of the pin (70) can be deformed by striking the second end (74) with an object, such as a ram, an anvil, a hammer or other suitable object.

When the second ends (74) of the plurality of pins (70) are deformed, the components between the first and second ends (72, 74) of the pins (70) can be constrained. Further, a clamp load can be applied on the vane rings (52, 54) and the spacers (78) as a result of the engagement of the head (76) of the pins (70) and the LVR (52) and the deformed second ends (74) of the pins (70) and the UVR (54). The pins (70) can also maintain circumferential angular orientation of the vane rings (52, 54) with respect to each other to maintain substantial alignment between the apertures (83, 84) for the vane axles (82) so as avoid jamming.

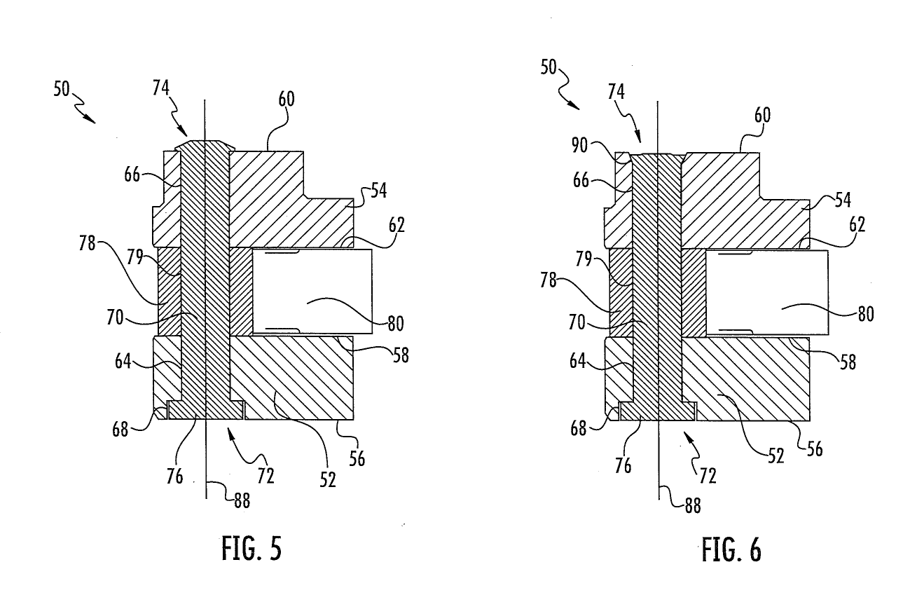

The deformed second ends (74) of the pins (70) may or may not protrude beyond the outer surface (60) of the UVR (54). In some instances, a protruding deformed second end (74) of the pin (70) may interfere with the rotation of the vane arm (86), depending upon the relative position of the apertures (64, 66) for the pins (70) and spacers (78) to the positions for the apertures (83, 84) for the vane axles (82) in the vane rings (52, 54), as. If the deformed second end (74) of the pins (70) would not interfere with the rotation of the vane arm (86), then at least a portion of the deformed second end (74) can protrude beyond the outer surface (60) of the UVR (54), as is shown in FIG. 5. The deformed second end (74) can have any suitable size, shaped and/or configuration. As an example, the deformed second end (74) can be flared or bulging. Such deformation can be achieved in any suitable manner. For instance, the second end (74) of the pin (70) can be displaced by an anvil impacting approximately in line with the centerline (88) of the pin (70). Alternatively, the deformed second end (74) can be domed, as is typically formed by the orbital riveting process. If the deformed second end (74) of the pin (70) cannot protrude above the outer surface (60) of the UVR (54), then the system can be configured to avoid such a condition. For instance, as depicted in FIG. 6, a recess (90) (e.g., a counterbore or countersink) can be provided in the UVR (54). The second end (74) of the pin (70) can be deformed, so that the material from the second end (74) of the pin (70) is deformed into the recess (90) of the UVR (54) while not protruding above the outer surface (60) of the UVR (54).

It will be appreciated that systems and methods described herein can provide numerous benefits. For instance, the manufacturing time and process steps for a vane pack can be reduced, as only one end of the pin is being deformed. Compared to prior efforts of clamping using expensive nuts and bolts, there can be cost savings as well. Further, embodiments herein can reduce uncertainty of maintaining a clamping force on the vane pack during turbocharger operation and at high temperatures. Additionally, the vane pack arrangements described herein can decouple the vane pack from the turbine housing, thereby avoiding problems due to differences in the rate of thermal expansion and contraction of the two materials. The part count of the vane pack can also be reduced, as the function of a bolt or stud and a nut can be achieved by a single pin.

It should be noted that while embodiments herein have been described with the head (76) of the pin (70) engaging the LVR (52) and the second end (74) of the pin (70) engaging the UVR (54), it will be appreciated that the opposite arrangement can be provided, That is, the head (76) of the pins (70) can engage the UVR (54) and the second end (74) of the pin (70) can engage the LVR (52). Further, it will be appreciated that combinations of such arrangements can be provided.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

Aspects described herein can be embodied in other forms and combinations without departing from the spirit or essential attributes thereof. Thus, it will of course be understood that embodiments are not limited to the specific details described herein, which are given by way of example only, and that various modifications and alterations are possible within the scope of the following claims.

What is claimed is:

1. A vane pack (50) for a variable geometry turbocharger comprising:
a first vane ring (52 or 54) having an inner surface (58 or 62) and an outer surface (56 or 60), a plurality of apertures (62 or 64) being provided in the first vane ring (52 or 54);
a second vane ring (52 or 54) having an inner surface (58 or 62) and an outer surface (56 or 60), a plurality of apertures (62 or 64) being provided in the second vane ring (52 or 54), each of the plurality of apertures (62 or 64) in the first vane ring (52 or 54) being substantially aligned with a respective one of the plurality of apertures (62 or 64) in the second vane ring (52 or 54);
a plurality of spacers (78) between the first and second vane rings (52, 54) to maintain a distance therebetween; and
a plurality of pins (70), each pin (70) having a first end (72) and a second end (74), the first end (72) of each pin (70) having a head (76), each pin (70) being received in a respective pair of aligned apertures (64, 66) in the first and second vane rings (52, 54) such that the head (76) of each pin (70) engages the first vane ring (52 or 54), the second end (74) of each pin (70) being deformed such that it engages the second vane ring (52 or 54), whereby a clamp load is applied to the first and second vane rings (52, 54) and the plurality of spacers (78).

2. The vane pack of claim 1, wherein the second end (74) of the pins (70) are deformed by orbital riveting.

3. The vane pack of claim 1, wherein each pin (70) passes through a respective one of the spacers (78).

4. The vane pack of claim 3, wherein the spacers (78) are separate from the pins (70).

5. The vane pack of claim 1, wherein the first vane ring is a lower vane ring (52), and second vane ring is an upper vane ring (54).

6. The vane pack of claim 1, wherein the head (76) of the pin (70) is substantially flush with or recessed from the outer surface (56 or 60) of the first vane ring (52 or 54).

7. The vane pack of claim 6, wherein the first vane ring (52 or 54) includes a counterbore (68), and wherein the head (76) of the pin (70) is received in the counterbore (68) such that wherein the head (76) of the pin (70) is substantially flush with or recessed from the outer surface (56 or 60) of the first vane ring (52 or 54).

8. The vane pack of claim 1, wherein the deformed second end (74) of the pin (70) protrudes beyond the outer surface (56 or 60) of the second vane ring (52 or 54).

9. The vane pack of claim 1, wherein the deformed second end (74) of the pin (70) is flush with or recessed from the outer surface (56 or 60) of the second vane ring (52 or 54).

10. A retention method for the vane pack (50) of a variable geometry turbocharger comprising:
providing a first vane ring (52 or 54) having an inner surface (58 or 62) and an outer surface (56 or 60), a plurality of apertures (64 or 66) being provided in the first vane ring (52 or 54);
providing a second vane ring (52 or 56) having an inner surface (58 or 62) and an outer surface (56 or 60), a plurality of apertures (64 or 66) being provided in the second vane ring (52 or 54);
providing a plurality of pins (70), each pin (70) having a first end (72) and a second end (74), the first end (72) of each pin (70) having a head (76);
inserting each pin (70) in a respective pair of substantially aligned apertures (64, 66) in the first and second vane rings (52, 54) such that the head (76) of each pin (70) engages the first vane ring (52 or 54); and
deforming the second end (74) of each pin (70) such that it engages the second vane ring (52 or 54), whereby a clamp load is applied to the first and second vane rings (52, 54).

11. The method of claim 11, wherein the deforming includes orbital riveting.

12. The method of claim 11, wherein the first vane ring is a lower vane ring (52), and second vane ring is an upper vane ring (54).

13. The method of claim 11, wherein the first vane ring is an upper vane ring (54), and second vane ring is a lower vane ring (52).

14. The method of claim 11, wherein the head (76) of the pin (70) is substantially flush with or recessed from the outer surface (56 or 60) of the first vane ring (52 or 54).

15. The method of claim 11, wherein the deformed second end (74) of the pin (70) protrudes beyond the outer surface (56 or 60) of the second vane ring (52 or 54).

16. The method of claim 11, wherein the deformed second end (74) of the pin (70) is flush with or recessed from the outer surface (56 or 60) of the second vane ring (52 or 54).
